(19) United States
(12) Patent Application Publication
(10) Pub. No.: US 2009/0037532 A1
(43) Pub. Date: Feb. 5, 2009

(54) RESPONSIVENESS RANKING FOR COLLABORATORS IN A COLLABORATIVE COMPUTING ENVIRONMENT

(75) Inventor: Miguel A. Estrada, Hollis, NH (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/832,971

(22) Filed: Aug. 2, 2007

(51) Int. Cl. G06F 15/16

(52) U.S. Cl. 709/205

(57) ABSTRACT

Embodiments of the present invention address deficiencies of the art in respect to collaborative messaging and provide a method, system and computer program product for responsiveness ranking for message recipients in a collaborative computing environment. In one embodiment of the invention, a method for responsiveness ranking of message recipients in a collaborative computing environment can be provided. The method can include computing a message response time for a particular message, a particular message recipient and a particular message type. The method further can include combining the computed message response time for the particular message, the particular message recipient and the particular message type with previously computed message response times for previously received messages for the particular message recipient and the particular message type. Finally, the method can include presenting different response times for different message types for a selected user based upon the combined computed message response times.

### BACKGROUND OF THE INVENTION

1. Field of the Invention

The present invention relates to the field of collaborative computing and more particularly to messaging systems for collaborative computing environments.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications, save for voice telephony.

The modern collaborative computing environment incorporates not only e-mail messaging, but also instant messaging, audio messaging including Internet telephony and video messaging within the same computing environment in order to consolidate person-to-person messaging irrespective of the underlying messaging technology. In a collaborative computing environment, users can be reached on an ad hoc basis according to messaging mechanism selected by the message sender. Accordingly, in the modern collaborative computing environment, it is incumbent upon the message sender to choose a proper mode of communications in order to receive a timely response to the message.

In this regard, message recipients respond to received messages with varying degrees of delay depending upon the message medium and the preference of the message recipients. Some recipients prefer e-mail as the primary source of messaging while others rely upon instant messaging. Yet others depend heavily on Internet telephony. To send an e-mail, then, to a message recipient accustomed to communicating predominately through instant messaging, would not necessarily result in a prompt response by the message recipient. Likewise, to leave a voice message with a message recipient accustomed to e-mail may not result in a prompt response by the message recipient. Accordingly, selecting an appropriate mode of message for a particular recipient can bear directly on the lapse of time before the recipient responds.

### BRIEF SUMMARY OF THE INVENTION

Embodiments of the present invention address deficiencies of the art in respect to collaborative messaging and provide a novel and non-obvious method, system and computer program product for responsiveness ranking for message recipients in a collaborative computing environment. In one embodiment of the invention, a method for responsiveness ranking of message recipients in a collaborative computing environment can be provided. The method can include computing a message response time for a particular message, a particular message recipient and a particular message type. The method further can include combining the computed message response time for the particular message, the particular message recipient and the particular message type with previously computed message response times for previously received messages for the particular message recipient and the particular message type.

Finally, the method can include preparing different response times for different message types for presentation to a selected user based upon the combined computed message response times. In this regard, the different response times can be presented in a user interface to indicate how best to communicate with different users. By way of example, different icons for different message types can be presented in a virtual business card for the selected user in order of fastest response time to indicate to a viewer how best to communicate with the selected user.

In another embodiment of the invention, a collaborative computing data processing system can be provided. The system can include different messaging servers for different message types and a response meter plug-in for each of the different messaging servers. Each response meter plug-in can include program code enabled to measure a response time for a received message. Finally, the system can include a message responsiveness manager coupled to each response meter plug-in. The message responsiveness manager can include program code enabled to combine response times measured in each of the response meter plug-ins to identify a likely response time for a particular user of the messaging servers for a particular one of the message types. Notably, the message types can include e-mail and instant messaging. Alternatively, the message types can include e-mail and voice mail and instant messaging.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative computing environment configured for responsiveness ranking of message recipients; and,

FIGS. 2A and 2B, taken together, are a flow chart illustrating a process for responsiveness ranking of message recipients in a collaborative computing environment.

### DETAILED DESCRIPTION OF THE INVENTION

Embodiments of the present invention provide a method, system and computer program product for responsiveness ranking of message recipients in a collaborative computing environment. In accordance with an embodiment of the present invention, message response times can be computed for individual messages received by a message recipient for different messaging types, for example e-mail, instant messaging and voice mail. The response times for each messaging type for each user can be averaged such that an average response time can be known at any time for a particular message recipient in respect to a particular messaging type. Consequently, the average response times for a prospective message recipient can be provided to a message composer such that the message composer can more ably select a most desirable messaging type to minimize response time.

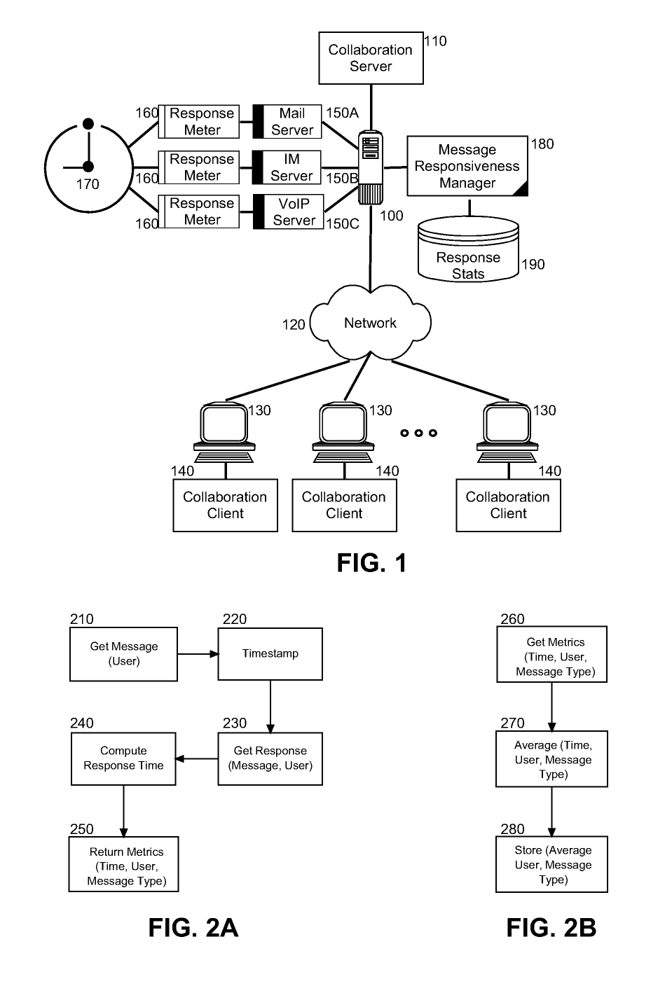

In further illustration, FIG. 1 is a schematic illustration of a collaborative computing environment configured for responsiveness ranking of message recipients. The system can include a host computing platform 100 supporting the operation of a collaboration server 110. The collaboration server 110 can provide collaborative computing services such as group calendaring and scheduling as well as messaging. The messaging service can include, by way of example, a mail server 150A, an instant messaging and collaboration server 150B and an Internet telephony server 150C supporting voice messaging. Each of the messaging servers 150A, 150B, 150C can be configured for access by one or more collaboration clients 140 operating in collaborative computing devices 130 coupled to the host computing platform 100 over a computer communications network 120.

Notably, a response meter plug-in 160 can be coupled to each of the servers 150A, 150B, 150C. Each response meter plug-in 160 can include program code enabled to computer a response time for a received message in a correspondingly coupled one of the servers 150A, 150B, 150C. To facilitate the computation of a response time for a received message, each of the response meter plug-ins 160 can access clock 170. The program code of each response meter plug-in 160 additionally can be enabled to forward a computed response time for a received message to a message responsiveness manager 180 coupled to the host computing platform 100. The message responsiveness manager 180, in turn, can be coupled to a data store of response metrics 190 such that received response times can be stored for use in data reduction.

In this regard, the message responsiveness manager 180 can include program code enabled to combine a set of response metrics on a message type and user basis to anticipate a likely response time for a user for a particular message type. For instance, the program code can be enabled to compute an average response time from a set of metrics received in association with a particular user and a particular message type. The program code of the message responsiveness manager 180 further can provide a programming interface to the collaboration server 110 and the collaboration clients 140 such that a message composer seeking to address a message to a particular recipient can view average response times for the particular recipient on a message type basis in order to select a message type most likely to result in an optimal response time by the particular recipient.

In yet further illustration, FIGS. 2A and 2B, taken together, are a flow chart illustrating a process for responsiveness ranking of message recipients in a collaborative computing environment. Beginning first in block 210 of FIG. 2A, a message can be received by a specific recipient user of the collaborative computing environment according to a specific message type, such as e-mail, instant message or voice mail. In block 220, a timestamp can be established for the received message. In block 230, a response can be determined for the message received by the recipient user. For instance, an outbound message specifically referencing the received message and addressed to the sender of the received message can be determined to be a response.

Upon detecting a response, a response time can be computed in block 240 based upon the timestamp. Thereafter, in block 250 the computed response time can be returned to the message responsiveness manager along with a reference to a specific user and a message type. Notably, a timeout value can be established for each plug-in to a messaging server. Once a timeout has been reached for a particular message without having received a response, it can be presumed that no response will be provided and the message can be dropped from consideration. Alternatively, a default max value metric can be returned to the message responsiveness manager. Finally, it is to be noted that the messages for which response time metrics can be computed can be limited to messages originating within an internal organization so as to avoid the consideration of unsolicited commercial e-mail when computing response time metrics.

Turning now to FIG. 2B, in block 260 response metrics for a particular user and message type can be received and, in block 270 an average can be computed for all response times for the particular user and message type. Though a simple average can be computed, more intense forms of data reduction can be performed including weighting different response time metrics for different responses according to selected criteria related to the different responses. Once an average has been computed for the particular user and message type, in block 280 the average can be stored for subsequent use along with the received response metrics. For example, the stored averages for a particular user and corresponding different message types can be presented to a message composer seeking to transmit a message to the particular user. In this way, the message composer can select an optimal message type to achieve a desired response time to the composed message.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for responsiveness ranking of message recipients in a collaborative computing environment, the method comprising:
computing a message response time for a particular message, a particular message recipient and a particular message type;
combining the computed message response time for the particular message, particular message recipient and particular message type with previously computed message response times for previously received messages for the particular message recipient and particular message type; and,
preparing different response times for different message types for presentation to a selected user based upon the combined computed message response times.

2. The method of claim 1, wherein computing a message response time for a particular message, particular message recipient and particular message type, comprises computing a message response time for a particular message transmitted only from within an organization, a particular message recipient in the organization and a particular message type.

3. The method of claim 1, further comprising:
detecting a timeout condition for a received message; and,
excluding the received message from computing a response time.

4. The method of claim 1, wherein combining the computed message response time for the particular message, particular message recipient and particular message type with previously computed message response times for previously received messages for the particular message recipient and particular message type, comprises averaging the computed message response time for the particular message, particular message recipient and particular message type with previously computed message response times for previously received messages for the particular message recipient and particular message type.

5. The method of claim 1, wherein preparing different response times for different message types for presentation to a selected user based upon the combined computed message response times, comprises preparing different response times for each of e-mail and instant messaging message types for presentation to a selected user based upon the combined computed message response times.

6. The method of claim 1, wherein preparing different response times for different message types for presentation to a selected user based upon the combined computed message response times, further comprises embedding an indication of the different response times in a virtual business card for the selected user in the collaborative computing environment.

7. A collaborative computing data processing system comprising:
a plurality of different messaging servers for different message types;
a response meter plug-in for each of the different messaging servers, each response meter plug-in comprising program code enabled to measure a response time for a received message; and,
a message responsiveness manager coupled to each response meter plug-in, the message responsiveness manager comprising program code enabled to combine response times measured in each of the response meter plug-ins to identify a likely response time for a particular user of the messaging servers for a particular one of the message types.

8. The system of claim 7, wherein the message types comprises e-mail and instant messaging.

9. The system of claim 7, wherein the message types comprises e-mail and voice mail and instant messaging.

10. The system of claim 7, wherein the program code of the message responsiveness manager is enabled to average response times measured in each of the response meter plug-ins to identify a likely response time for a particular user of the messaging servers for a particular one of the message types.

11. A computer program product comprising a computer usable medium embodying computer usable program code for responsiveness ranking of message recipients in a collaborative computing environment, the computer program product comprising:
computer usable program code for computing a message response time for a particular message, a particular message recipient and a particular message type;
computer usable program code for combining the computed message response time for the particular message, the particular message recipient and the particular message type with previously computed message response times for previously received messages for the particular message recipient and the particular message type; and,
computer usable program code for preparing different response times for different message types for presentation to a selected user based upon the combined computed message response times.

12. The computer program product of claim 10, wherein the computer usable program code for computing a message response time for a particular message, a particular message recipient and a particular message type, comprises computer usable program code for computing a message response time for a particular message transmitted only from within an organization, a particular message recipient in the organization and a particular message type.

13. The computer program product of claim 11, further comprising:
computer usable program code for detecting a timeout condition for a received message; and,
computer usable program code for excluding the received message from computing a response time.

14. The computer program product of claim 11, wherein the computer usable program code for combining the computed message response time for the particular message, the particular message recipient and the particular message type with previously computed message response times for previously received messages for the particular message recipient and the particular message type, comprises computer usable program code for averaging the computed message response time for the particular message, particular message recipient and particular message type with previously computed message response times for previously received messages for the particular message recipient and particular message type.

15. The computer program product of claim 11, wherein the computer usable program code for preparing different response times for different message types for presentation to a selected user based upon the combined computed message response times, comprises computer usable program code for preparing different response times for each of e-mail and instant messaging message types for presentation to a selected user based upon the combined computed message response times.

16. The computer program product of claim 11, wherein the computer usable program code for preparing different response times for different message types for presentation to a selected user based upon the combined computed message response times, further comprises computer usable program code for embedding an indication of the different response times in a virtual business card for the selected user in the collaborative computing environment.
